(19) United States
(12) Patent Application Publication
(10) Pub. No.: US 2015/0077362 A1
(43) Pub. Date: Mar. 19, 2015

(54) TERMINAL WITH FINGERPRINT READER AND METHOD FOR PROCESSING USER INPUT THROUGH FINGERPRINT READER

(71) Applicant: Pantech Co., Ltd., Seoul (KR)

(72) Inventor: Jun-Hyuk SEO, Gunpo-si (KR)

(21) Appl. No.: 14/451,789

(22) Filed: Aug. 5, 2014

(30) Foreign Application Priority Data
Sep. 16, 2013 (KR) 10-2013--0111437

(51) Int. Cl. G06F 3/041; G06K 9/00; G06F 3/0488

(52) U.S. Cl. CPC G06F 3/041; G06F 3/04883; G06K 9/00013; G06K 9/00087; G06F 2203/04808
USPC 345/173

(57) ABSTRACT

In a terminal including a fingerprint reader and a method for processing a user's input through the fingerprint reader, the terminal includes: a fingerprint reader configured to acquire fingerprint data by recognizing a fingerprint or to acquire touch input data including information on positions recognized by touch or movement of a touching device; a signal converter configured to convert touch input data received from the fingerprint reader into an input signal of a mode selected from among input signals of one or more modes; and an execution controller configured to control applications according to the input signal received from the signal converter.

### CROSS-REFERENCE TO RELATED APPLICATION(S)

This application claims priority from and the benefit of Korean Patent Application No. 10-2013-0111437, filed on Sep. 16, 2013, in the Korean Intellectual Property Office, the entire disclosure of which is incorporated herein by reference for all purposes as if fully set forth herein.

### BACKGROUND

1. Field

The following description relates generally to a terminal and, more particularly, to a technology for processing user input through a fingerprint reader or sensor provided for or in a terminal.

2. Description of the Related Art

Recently, mobile computing devices or smart mobile devices (hereinafter simply referred to as “mobile terminals”), such as smartphones or tablet computers, each with a mobile operating system (OS) mounted thereon, are being widely used. The development of information technology (IT) has continuously improved hardware performance of mobile terminals, and extensive digital convergence enables various hardware modules to be integrated into mobile terminals. Users can enjoy various hardware modules installed in mobile terminals as well as install many application programs in their mobile terminals for various usage and purposes.

One example of such hardware modules that may be integrated into the mobile terminal is a fingerprint reader. The fingerprint reader is a device that reads a user's fingerprint by using a fingerprint scanner, and is usually installed in the mobile terminal for user verification. For example, the fingerprint reader may be used as a tool for lock release of a mobile terminal and/or for safe financial transactions when using specific applications, e.g., financial applications such as bank or stock applications. For user verification, a fingerprint may be used alone or in combination with other verification methods or devices, e.g., password protection.

One type of such fingerprint reader is a sweep-type fingerprint reader. In a conventional fingerprint reader, a user places their finger on a sensing surface of a fingerprint reader and holds their finger thereon for a time. By contrast, in a sweep-type fingerprint reader, a user sweeps or swipes their finger across a sensing surface of a fingerprint reader, and the user's fingerprint is recognized by combining a plurality of frame images, which include partial fingerprint images of a fingerprint, obtained during a certain time interval and by extracting feature points of the whole fingerprint by combining the frame images including the partial fingerprints.

As a display of the latest mobile terminal is increasingly getting bigger in size, for example, 5 inches or more, a fingerprint reader is usually disposed at or on the back of a mobile terminal to provide portability of a bigger mobile terminal. In a case where a fingerprint reader is disposed at the back of a mobile terminal, a user may sweep a sensing surface of the fingerprint reader with a finger of a hand that is holding the mobile terminal, or with a finger of a hand other than the hand that is holding a mobile terminal.

As the types of mobile terminals, particularly smart mobile terminals, such as smartphones and the like, are being diversified, smart mobile terminals have adopted many operations that provide various user experiences and/or user convenience, and research and development thereon has been actively conducted. However, a fingerprint reader has conventionally been used with a focus on user verification rather than on operations that provide various user experiences. Accordingly, a fingerprint reader provided for a mobile terminal is needed to be used to provide various user experiences and improve user convenience.

### SUMMARY

Exemplary embodiments provide a terminal including technology for processing user input through a fingerprint reader or sensor.

Additional aspects will be set forth in the detailed description which follows, and, in part, will be apparent from the disclosure, or may be learned by practice of the inventive concept.

Aspects of the present invention provide a terminal including: a fingerprint reader to acquire fingerprint data or to acquire touch input data according to a mode of the fingerprint reader; an input processor comprising a signal converter to convert the touch input data received from the fingerprint reader into an input signal according to a mode of the signal converter, the mode of the signal converter being determined according to an application or a user input; and an execution controller to control the application according to the input signal received from the signal converter.

Aspects of the present invention provide a method of controlling execution of an application of a terminal, the method comprising: determining a mode of a fingerprint reader from among a fingerprint recognition mode and a touch sensing mode; acquiring touch input data through the fingerprint reader if the mode of the fingerprint reader is determined as the touch sensing mode; generating an input signal from the touch input data according to an application or a user input; and controlling the application according to the input signal.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain the principles of the inventive concept.

The above and other features and advantages of the present disclosure will become readily apparent by reference to the following detailed description when considered in conjunction with the accompanying drawings.

FIG. 1 is a block diagram illustrating an example of a mobile terminal with a fingerprint reading reader according to exemplary embodiments.

FIG. 2 is a detailed diagram illustrating operations of an input processor and an execution controller of the mobile terminal in FIG. 1 according to exemplary embodiments.

FIG. 3 is a diagram illustrating an example of the configuration of FIG. 2 embodied on the Android operating system (OS) according to exemplary embodiments.

FIG. 4 is a flowchart illustrating an example of processing user input through a fingerprint reading reader of a mobile terminal according to exemplary embodiments.

FIG. 5A is a diagram illustrating an example of an initial image of a running image viewer application displayed on a screen according to exemplary embodiments.

FIG. 5B is a diagram illustrating an example of an image displayed when the image selected in the initial image of FIG. 5A is clicked according to exemplary embodiments.

FIG. 6A is a diagram illustrating an example of an image of connection to a mobile Internet portal site through an Internet browser according to exemplary embodiments.

FIG. 6B is a diagram illustrating an example of an image displayed when a news item selected in the image of FIG. 6A is clicked according to exemplary embodiments.

FIG. 7 is a diagram illustrating an example of a menu image of a mobile terminal with the Android OS mounted thereon according to exemplary embodiments.

FIG. 8 is a diagram illustrating an example of an image displayed when executing one of drawing applications in a mobile terminal with the Android OS mounted thereon according to exemplary embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

In the present disclosure, mobile terminals, such as smartphones, smartpads, phablets, and the like, are used to explain exemplary embodiments of the inventive concept, but the present disclosure is not limited to mobile terminals, and may also be applied to fixed devices, such as personal computers and the like. Accordingly, the “terminal” indicated in the present disclosure should be construed to include a fixed device as well as a mobile terminal.

Further, in the present disclosure, operations of a mobile terminal, such as “performing lock release of a mobile terminal,” “performing operations supported thereby,” and “executing applications installed therein,” which are determined by a mobile terminal using a fingerprint verification or a user's touch input, will be simply referred to as “application execution” or variations thereof or the like. This simplified expression is intended to prevent unnecessary misunderstanding. Accordingly, “application execution” indicated in the present disclosure should be construed as to include at least the above operations unless the expression is contrary to specific details of the present disclosure and/or common knowledge in the art.

Further, module, unit, or the like may be hardware, firmware or software implemented on hardware or a processor or the like, or combinations thereof. Further, a module, unit, or the like may be implemented by one or more processors.

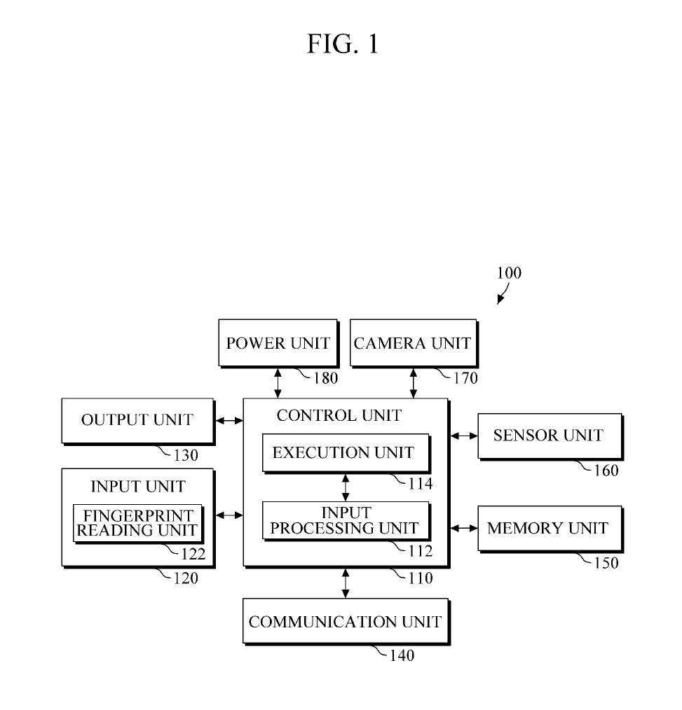

FIG. 1 is a block diagram illustrating an example of a mobile terminal with a fingerprint reader or reading unit according to an exemplary embodiment. The mobile terminal 100 illustrated in FIG. 1 has a specific operating system (OS), such that various applications may be installed and executed. The mobile terminal 100 may be a smartphone, or a tablet computer, but is not limited thereto. Examples of the mobile terminal 100, on which a specific mobile operating system is mounted, include a personal multimedia player (PMP), a game console, a navigation device, an e-book reader, a laptop computer and the like. Further, various hardware modules may be installed in the mobile terminal 100. As described above, the exemplary embodiments of the inventive disclosure may also be applied to a fixed terminal, other than a mobile terminal, which has a fingerprint reader and a specific OS so that various programs may be installed to be executed.

Referring to FIG. 1, the mobile terminal 100 includes a control unit 110 (e.g., a controller), an input unit 120 (e.g., an input receiver), an output unit 130 (e.g., an output device), a communication unit 140 (e.g., a transceiver), a memory unit 150 (e.g., a memory), a sensor unit 160 (e.g., a sensor), a camera unit 170 (e.g., a camera), and a power unit 180 (e.g., a power source), in which the control unit 110 includes an input processing unit 112 (e.g., an input processor) and an execution unit 114 (e.g., an execution controller), and the input unit 120 includes a fingerprint reading unit 122 (e.g., a fingerprint reader).

The mobile terminal 100 illustrated in FIG. 1 is an example of a mobile terminal with a fingerprint reader. Accordingly, the mobile terminal is not required to include all the devices/units illustrated in FIG. 1, and one or more devices/units may not be included. For example, the mobile terminal 100 may not include a sensor unit 160 or a camera unit 170. Further, the mobile terminal 100 may include additional devices/units for operations thereof, and additional devices/units may vary depending on the types and operations of the mobile terminal 100. For example, the mobile terminal 100 may further include a vibration generation unit, a global positioning system (GPS) unit, a digital multimedia broadcasting (DMB) unit, a wired communication unit, and the like. In addition, constituent elements illustrated in FIG. 1 are illustrated for convenient explanation, and two or more constituent elements may be configured as one element, or one constituent element may be divided into two or more constituent elements. Further, each constituent element may be divided physically or according to their operations.

The mobile terminal 100 may provide various operations using various constituent elements described above, and users may use various hardware units of the mobile terminal for many purposes. Various applications may be installed in the mobile terminal 100. The applications refer to software to provide specific services or operations in the mobile terminal 100, including always-on-top applications or service objects as well as common applications. In the Android OS, applications refer to apps as well as service objects. These applications are not limited to the ones installed in advance by manufacturers or mobile carriers, and may include applications downloaded or generated and installed by users.

The control unit 110 performs operations of managing, processing, and controlling overall operations of the mobile terminal 100. For example, the control unit 110 may control operations and process signals required for executing specific units, external devices, or applications. Further, the control unit 110 may control the communication unit 140 to enable the mobile terminal 100 to communicate with a service provider or other mobile terminals or devices for data communications or voice/video calls, and may also process transmission and reception signals. The control unit 110 may perform specific processes in response to visual, auditory, and mechanical/physical input signals received from the input unit 120, the sensor unit 160, the camera unit 170, or the like, and may control the output unit 130 to output processing results of input signals and/or overall execution results performed by the control unit 110 into visual, auditory, and mechanical/physical input signals. In addition, the control unit 110 may store, in the memory unit 150, data that is input from the input unit 120, received from the communication unit 140, and generated according to application execution results, and may perform overall management of files, such as importing or updating of files stored in the memory unit 150.

Further, the control unit 110 may perform user verification using fingerprint data received from the fingerprint reading unit 122, and may process signals and control constituent elements to complete user verification. More specifically, the control unit 110 may recognize a fingerprint by controlling the fingerprint reading unit 122 to be operated in a fingerprint recognition mode, and by processing fingerprint data received through this process. Further, by comparing the recognized fingerprint with a pre-registered fingerprint, the control unit 110 verifies a user, and controls operations or execution of applications based on the verification.

The control unit 110 may process input signals of various modes using touch input data received from the fingerprint reading unit 122. More specifically, the control unit 110 controls the fingerprint reading unit 122 to be operated in a touch sensing mode to process touch input data received from the fingerprint reading unit 122. “Touch input data received from the fingerprint reading unit 122” or simply “touch input data,” may refer to user input signals input by touch and/or movement of a touching device (e.g., finger or a touch pen) on the fingerprint reading unit 122 operated in the touch sensing mode. Further, the control unit 110 may generate input signals of a mode optimized for an application that is running or operations thereof by using the processed touch input data, and accordingly, controls execution of the application or operations thereof.

The control unit 110 may include the input processing unit 112 and the execution unit 114. The input processing unit 112 may generate verification result signals indicative of fingerprint verification results obtained by processing fingerprint data received from the fingerprint reading unit 122 operated in a fingerprint recognition mode. Further, the input processing unit 112 may process touch input data received from the fingerprint reading unit 122 operated in the touch sensing mode to generate input signals of a specific mode. In response to verification result signals or input signals of a specific mode received from the input processing unit 112, the execution unit 114 may control execution of applications or specific operations thereof.

Generally, the input processing unit 112 and the execution unit 114 may process input data not only from the fingerprint reading unit 122, but also from other input units, for example, the input unit 120, the sensor unit 160, the camera unit 170, or the like. However, in the present disclosure, it is assumed that the input processing unit 112 and the execution unit 114 process input, e.g., fingerprint data or touch input data, received from the fingerprint reading unit 122, and control execution of applications through this process. Further, the input processing unit 112 and the execution unit 114 are logically divided according to their operations, and may be configured as one integrated unit, or may be separated as individual units.

Referring to FIG. 1, the input unit 120 and the output unit 130 constitute a user interface of the mobile terminal 100. The input unit 120 inputs user data, instructions, or request signals to the mobile terminal 100. The output unit 130 outputs data, information, or signals processed in the mobile terminal 100. More specifically, the input unit 120 may include a microphone to receive voice or auditory data, a keypad to receive data, instructions, or the like, a dome switch, a button, a jog wheel, a touchpad, a touch screen, and the like. The output unit 130 may include a display to output image signals or video signals, an audio output device, such as a speaker and/or an ear jack, to output audio signals, a vibration unit to output mechanical signals (e.g., vibration), an aroma output unit, and the like.

The input unit 120 may include a fingerprint reading unit 122. The fingerprint reading unit 122 may be or include a fingerprint reader or a fingerprint recognition sensor, and may be disposed on the back of the mobile terminal 100, but the disposition is not limited thereto, for example, the fingerprint reading unit 122 may be disposed along an edge or on the face of the mobile terminal 100. The fingerprint reading unit 122 may operate in a fingerprint recognition mode to recognize a user's fingerprint, or may operate in a touch sensing mode to receive touch input from a user. The two modes are sufficient for the fingerprint reading unit 122 to operate, but the types or operation modes of the fingerprint reading unit 122 are not limited thereto. For example, the fingerprint reading unit 122 may be a sweep-type fingerprint sensor, and/or the fingerprint reading unit 122 may be in an off mode. Further, the fingerprint reading unit 122 may be combined with a touch pad and/or touch screen or other elements.

Further, the fingerprint reading unit 122 may operate in any one of the two operation modes, which may be determined by a user. For example, a user may set the operation modes for each application or each execution process of an application, and the mobile terminal 100 may provide a specific user interface. The fingerprint reading unit 122 may operate in any one operation mode appropriate for a type of an application that is running, executed, or active and/or for each execution process of an application. For example, in a case where a fingerprint verification application is being executed or a fingerprint verification process of a specific application (e.g., a financial application, such as bank application, and the like) is being performed, the fingerprint reading unit 122 may operate in a fingerprint recognition mode. By contrast, if an application (e.g., applications related to the Internet, games, multimedia, etc.) that is not relevant to fingerprint verification is being executed, or an execution process other than the fingerprint verification process of a financial application is being executed, the fingerprint reading unit 122 may operate in a touch sensing mode.

Although not shown in FIG. 1, the fingerprint reading unit 122 may further include a separate constituent element to select and/or determine input or operation modes of the fingerprint reading unit 122. For example, an operation mode selector may be included in the control unit 110 of the mobile terminal 100, in which the operation mode selector may be integrally formed as one operational unit with the input processing unit 112 or the execution unit 114, or may be configured as a operational unit separate from the input processing unit 112 or the execution unit 114. The operation mode selector may provide a user interface to enable a user to select operation modes, and may manage information on operation modes selected by a user. Further, the operation mode selector may determine and select operation modes of the fingerprint reading unit 122 according to the types of applications and/or according to each execution process of applications. Moreover, the input unit 120 or the fingerprint reading unit 122 may include a physical switch, as the operation mode selector, configured to select the operation mode of the fingerprint reading unit 122, and the physical switch may be integral with, disposed adjacently to, or disposed separately from the input unit 120 or the fingerprint reading unit 122. Further, another input unit, for example, a power button, may be operated to select the operation mode of the fingerprint reading unit 122, for example, by a long press or by multiple presses.

The mobile terminal 100 may include a touch screen disposed on the front surface thereof. The mobile terminal 100 may include plural touch screens disposed on plural sides of the mobile terminal 100. The touch screen, which is one of user interfaces for interaction between a user and the mobile terminal 100, performs a touch pad operation as a constituent element of the input unit 120 as well as a display operation as a constituent element of the output unit 130. The touch screen may have a structure in which the touch pad as an input element and the display as an output element are combined and stacked, or the touch pad and the display are integrally formed. A user may input instructions or information into the mobile terminal 100 by touching a touch screen, on which a user interface is displayed, directly or with a stylus pen. The mobile terminal 100 may output texts, images, and/or videos through the touch screen for users.

The communication unit 140 transmits and receives electromagnetic signals to communicate with a wireless communication network and/or other electronic devices, and may include a mobile communicator for audio, video, and data communication according to a mobile communication standard, a Wi-Fi® communicator for a wireless local area network (WLAN) communication, a near field communicator for near field communication (NFC), and the like. Further, the memory unit 150 stores operating system programs, applications, various types of data, and the like, for operating the mobile terminal 100. The sensor unit 160 senses positions or movements of the mobile terminal 100, brightness of the surroundings, or the like, and may include a gravity sensor, a proximity sensor, an accelerometer, a motion sensor, an illumination sensor, and the like. Further, the camera unit 170 acquires image/video signals, and the power unit 180 supplies power necessary for the operation of the mobile terminal 100.

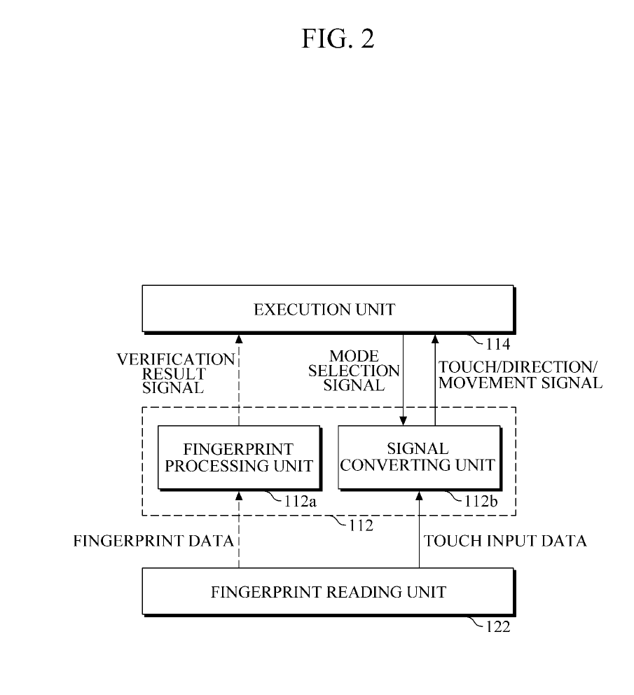

FIG. 2 is a detailed diagram illustrating operations of an input processing unit and an execution unit of the mobile terminal in FIG. 1. As described above, the fingerprint reading unit 122 may operate in a fingerprint recognition mode or in a touch sensing mode, and specific operation methods performed according to each of the two modes will be described hereinafter.

In a case where the fingerprint reading unit 122 operates in a fingerprint recognition mode, the fingerprint reading unit 122 acquires fingerprint data, and transmits the acquired fingerprint data to a fingerprint processor or fingerprint processing unit 112a of the input processing unit 112. The fingerprint data is raw data for recognizing a fingerprint acquired from the fingerprint reading unit 122, and may include, for example, recognized fingerprint images. Specific methods used by the fingerprint reading unit 122 to acquire fingerprint data may vary depending on the types of the fingerprint reading unit 122. Further, the fingerprint processing unit 112a processes the fingerprint data received from the fingerprint reading unit 122 with a specific algorithm to recognize the fingerprint (e.g., extract information on feature points of a fingerprint).

The fingerprint processing unit 112a may also process the recognized fingerprint by a specific method according to an application that is running or according to operations thereof. For example, if an application for registering a fingerprint is running, a fingerprint recognized by the fingerprint processing unit 112a may be transmitted to the memory unit 150 (see FIG. 1) to be registered and stored as a user fingerprint. For example, if an application or an operation for user verification is running, the fingerprint processing unit 112a may compare a recognized fingerprint with a pre-registered fingerprint to determine sameness, and transmits a verification signal, which indicates a user (fingerprint) verification result, to the execution unit 114. In this case, the execution unit 114 may control the application itself, or subsequent execution phases thereof, to be executed or not to be executed.

In a case where the fingerprint reading unit 122 operates in a touch sensing mode, the fingerprint reading unit 122 acquires touch input data, and transmits the acquired data to a signal converter or signal converting unit 112b of the input processing unit 112. The touch input data is raw data related to a user's touch input acquired from the fingerprint reading unit 122, and may include information on positions recognized by, for example, touch or movement of a touching device (e.g., a finger, a touch pen, etc.).

Specific methods used by the fingerprint reading unit 122 to acquire the touch input data may vary depending on the types of the fingerprint reading unit 122, and in the present disclosure, the methods are not specifically limited. For example, the fingerprint reading unit 122 of a scanning type may acquire touch input data by measuring positions of points of contact where a touching device touches and/or measuring changes in the positions of points of contact, whereas the fingerprint reading unit 122 of a sweep type may acquire touch input data by measuring positions of movement or displacement of a touching device.

The signal converting unit 112b may generate input signals of various modes by processing touch input data received from the fingerprint reading unit 122. That is, the signal converting unit 112b supports generation of input signals according to one or more modes. For example, the signal converting unit 112b may calculate displacement (ΔX, ΔY) during a specific time interval based on position information transmitted from the fingerprint reading unit 122. Then, after the signal converting unit 112b calculates coordinates data (X, Y), displacement data (ΔX, ΔY), or directions data (X direction and/or Y direction) according to an input mode determined using the displacement (ΔX, ΔY), the signal converting unit 112b may generate any one input signal according to an input mode, among input signals of one or more modes, and transmits the generated input signal to the execution unit 114. Depending on examples, a separate constituent element, e.g., an input mode selector (not shown) may be further provided to select and determine an input mode, and to transmit information on the determined input mode to the signal converting unit 112b. The execution unit 114 may control an application to be executed in response to an input signal of a specific mode that is received from the signal converting unit 112b.

The signal converting unit 112b may generate any one signal among a touch signal, a direction signal, and a movement signal according to a determined input mode. However, these signals are merely illustrative, and it would be evident to one of ordinary skill in the art that input signals for other input modes may also be generated depending on examples. For example, in a case where an input mode is determined to be a touch input mode, the signal converting unit 112b may generate a touch signal from touch input data. Such touch signal may include gesture information as well as coordinate information. If an input mode is determined to be a direction input mode, the signal converting unit 112b may generate a direction signal from touch input data. If an input mode is determined to be a movement input mode, the signal converting unit 112b may generate a movement signal from touch input data. A touch signal, a direction signal, and a movement signal will be described in detail later.

Generating an input signal according to any one mode among various input modes may be different from generating an input signal according to one specific input mode because, in the former case, the signal converting unit 112b may generate an input signal appropriate for an application that is running and/or for the application's execution phase, whereas in the latter case, only an input signal of any one predetermined mode may be generated regardless of an application that is running or the application's execution phase. Particularly, in the latter case, a mode of an input signal may not be changed, such that a user's touch input may not be used appropriately as an input signal required for an application and/or the application's execution phase.

A touch signal is generally a signal that is sensed by a touch panel or a touch sensor, and in a mobile terminal with a touch screen including a touch panel and a display, it may be a signal that is generated by sensing a touch of a specific point of an image displayed on a display. Accordingly, the touch signal may include information on a position corresponding to a resolution of a display, e.g., coordinate information on X and Y coordinates. The signal converting unit 112b may process the received touch input data, which includes position information, into coordinate information that is position information corresponding to a resolution of a display. The touch signal is not limited to coordinate information indicated by a touching device at a specific point in time, and may be coordinate information and/or changes therein indicated by a touching device during a specific time interval. In the latter case, a touch signal may be a signal converted from a gesture of a touching device that is obtained from coordinate information and/or changes therein. For example, a touch signal may be converted into a signal used for zooming in/out images displayed on a display (zoom signal), moving images on a display from left to right (image scroll signal), turning over pages on a display (flick signal), selecting a specific item (e.g., a file icon, an application icon, or the like) to execute additional operations (e.g., delete) (long touch signal), or for selecting a specific item (e.g., a file) to move the item (drag signal).

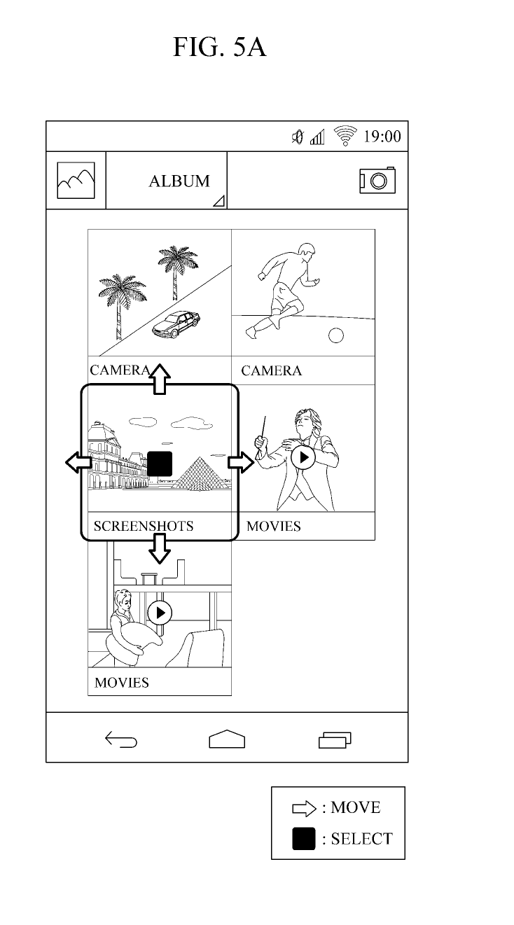

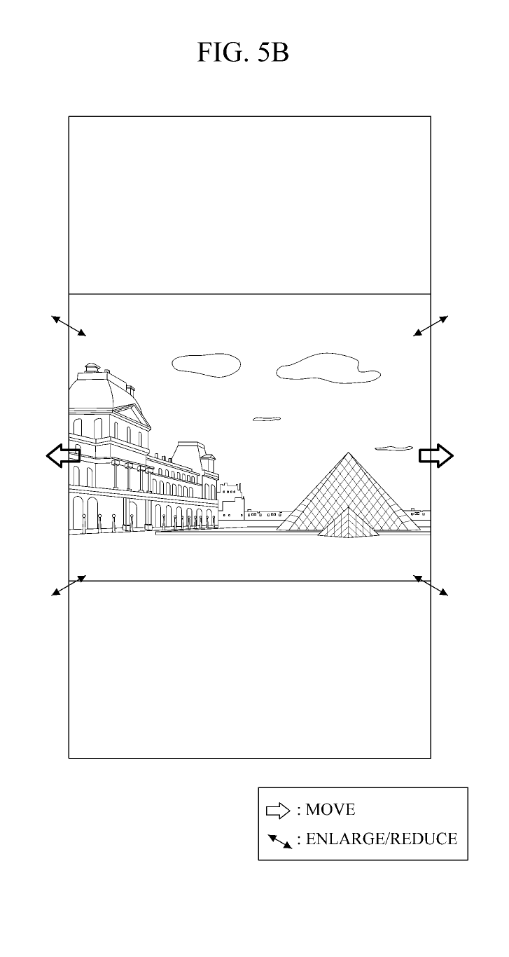

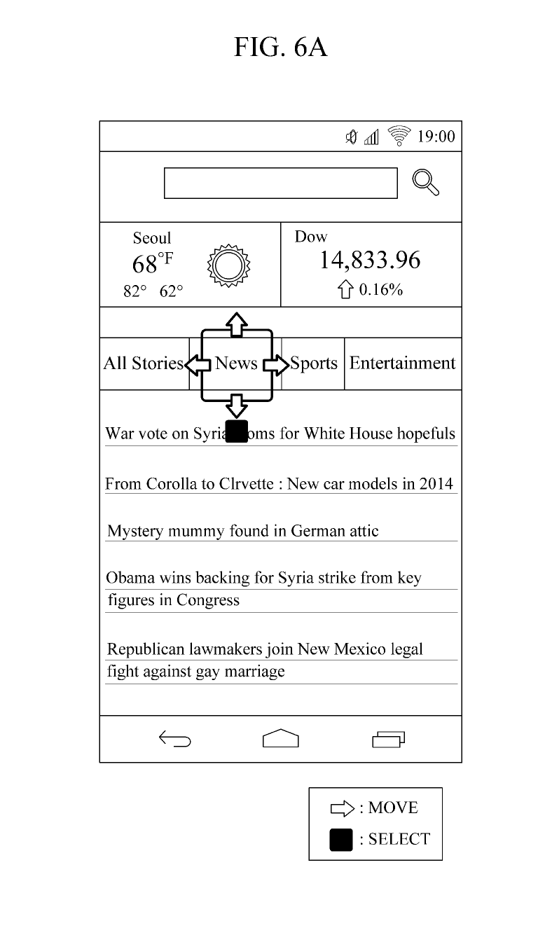

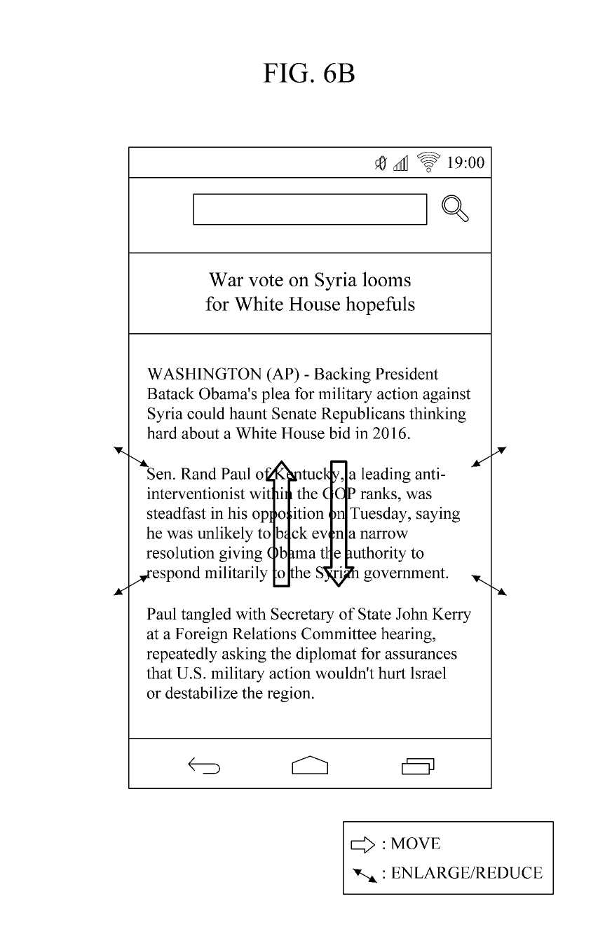

In a case where items are displayed on a display of a mobile terminal, among which any one item is highlighted or pre-selected, as indicated in FIGS. 5A and 6A, a direction signal is used to change the highlighted or pre-selected item. Herein, that “any one item is highlighted or pre-selected” indicates a state where an indicator for selecting the item is positioned on the item or focused thereon, unlike a state where an item is selected from among a plurality of items displayed on a display or a state of multiple selecting. A state where an item is highlighted or pre-selected may be displayed with an indicator overlaid on or with the item, or the pre-selected item may be displayed with a visual distinction from other items by being outward-looking or inward-looking compared to the other items. Further, the highlighted or pre-selected item may be displayed brighter or dimmer relative to the other items or with shading or highlighting of the colors of the item.

In order to execute the highlighted item in a direction input mode, another input (e.g., clicking or pressing enter) is required. However, aspects need not be limited thereto such that another input may be performed by various input methods. For example, other input devices (e.g., a side button, a dome key, etc., of a mobile terminal) may be used, or one or more additional touch inputs through a fingerprint reader or into a touch screen, or a dome key, touch pad, or touch screen provided at the bottom of or adjacent to a fingerprint reader may also be used.

The direction signal may be referred to as a “trackball signal,” since on a screen where a plurality of items are listed, the direction signal is similar to a mouse trackball, which moves back and forth to change pre-selected items, or to a tab button on a keyboard, which is used to changed pre-selected items. Otherwise, depending on examples, the direction signal may be referred to as a “focus signal.”

The direction signal may include information on directions of touch input movement based on a position where a user views a display, that is, information on the X-direction and/or Y-direction. The signal converting unit 112b may generate a direction signal using the received touch input data, which includes changes in position information during a specific time interval. With a plurality of selectable items displayed on a display, the direction signal may be used to change positions pre-selected from a specific item to another item. In this case, the highlighted item may be changed by moving an indicator between adjacent items in a direction indicated by the direction signal, or by changing visually distinguished items. For example, the direction signal may be used to change highlighted applications one by one in a case where a plurality of application icons are arranged in an array, or in a case where a plurality of pieces of information (e.g., Internet news, phone book data, icons, lists of content or documents, etc.) are arranged horizontally and/or vertically on a display.

Such direction signal may not include specific information on variance in movement directions. Rather, variance according to the direction signal may be predetermined or set according to device, application, manufacturer settings and the like. For example, regardless of degrees of change, items that are highlighted by the direction signal may be changed in that direction one by one. In contrast, in a case where a threshold of change in position information is determined, if there is a change in the position information below a determined threshold, selected items may be set to be changed one by one, but if there is a change in the position information above a determined threshold, selected items may be set to be changed by two or more (e.g., a multiple of the threshold).

A movement signal is a signal to change selection points on a display of a mobile terminal. For example, the movement signal may also be referred to as a mouse signal, since the movement signal performs a function similar to changing positions of a cursor or mouse pointer corresponding to movement or selection of a computer mouse. The movement signal may include information on variance or difference in positions of an indicator or mouse pointer, e.g., information on X axis variance or difference and Y axis variance or difference. The signal converting unit 112b may process the received touch input data, which includes changes in position information during a specific time interval, as variance or difference information, e.g., information on variance or difference in X-axis and Y-axis coordinates. The movement signal may be used, for example: to change an application indicated by a mouse pointer if application icons are arranged in an array or in a list; to change a position indicated by a mouse pointer on a display where images, such as a map and the like, are displayed, for example, an image to be displayed on a display may be changed or moved in order to adjust a position of a mouse pointer to be at the center of the display; or to draw a line in a specific direction if a drawing application or an application's drawing function is running.

As described above, upon receiving touch input data from the fingerprint reading unit 122, the signal converting unit 112b may generate signals according to a specific input mode predetermined, determined, or set among a plurality of supportable input modes. That is, the signal converting unit 112b operates in a specific mode predetermined among a plurality of input modes to generate input signals according to the specific mode. Further, the signal converting unit 112b may operate in an input mode that is set and selected manually by a user, or in an input mode that is set and selected automatically without a user's involvement in consideration of an application that is running and/or the application's execution phase.

Although not illustrated in FIG. 2, a separate constituent element to select and/or determine an input or operation mode, in which the signal converting unit 112b operates, may be further included. For example, an input mode selector may be further included in the control unit 110 (see FIG. 1) of the mobile terminal 100 (see FIG. 1). For example, an input mode selector may be integrally formed with the signal converting unit 112b or the execution unit 114 to be implemented as an operation unit of the signal converting unit 112b or the execution unit 114, or may be implemented as an operation unit separately from the single converting unit 112b or the execution unit 114. Further, an input mode selector may be implemented separately from the above-mentioned operation mode selector configured to select and/or determine an operation mode for the fingerprint reading unit 122, or may be integrally formed with the operation mode selector. In the latter case, the input mode selector may be implemented as a sub operational unit or a sub menu (a menu that is run only when a touch input mode is selected as an operation mode) of the operation mode selector.

Such input mode selector may provide a user interface for selecting an input mode in which the signal converting unit 112b operates, e.g., the types of input signals generated by the signal converting unit 112b. Further, the input mode selector may select and determine operation modes according to a type of an application that is running and/or operation modes of the fingerprint reading unit 122 according to the application's execution phase, and may transmit information on a selected operation mode to the fingerprint reading unit 122.

The input mode selector may also manage information based on the selected input mode selected by a user or according to an application that is running and/or according to the application's execution phase. Here, the managing of information on the selected input mode includes setting input modes for each application and/or each execution phase of applications, and storing information on the set input modes. Further, the managing of information on the selected input mode includes controlling the signal converting unit 112b to be operated according to a previously set input mode in a case where a mobile terminal is turned on again, or an application is executed again.

The signal converting unit 112b may generate signals according to an input mode pre-selected or predetermined by a user among the plurality of input modes described above. That is, the signal converting unit 112b may operate in a specific input mode selected by a user to generate an input signal according thereto. The control unit 110 of a mobile terminal (see FIG. 1), e.g., the above-mentioned input mode selector may provide a user interface (UI) for a user to select input modes of the signal converting unit 112b through the input unit 120 and the output unit 130 (see FIG. 1), e.g., a touch screen.

For example, the user interface for a user to select input modes of the signal converting unit 112b may be powered on as the power unit 180 (see FIG. 1) supplies power to the mobile terminal 100 (see FIG. 1), and then, when the fingerprint reading unit 122 is set to be used, the user interface may be provided. As another example, when the mobile terminal 100 is powered on, the signal converting unit 112b may operate in an input mode determined before the mobile terminal 100 was powered off, without the user interface provided. Further, when the mobile terminal 100 remains in a powered-on state, the control unit 110 may provide a user interface, e.g., a separate setting menu, to select or change input modes of the signal converting unit 112b in response to a user's request or based on a specific internal algorithm.

Through such user interface for a user to select input modes of the signal converting unit 112b, information on an input mode selected by a user, e.g., a mode selection signal may be transmitted to the signal converting unit 112b. FIG. 2 illustrates that the mode selection signal is transmitted from the execution unit 114 to the signal converting unit 112b, which is merely illustrative, and the present disclosure is not limited thereto.

According to exemplary embodiments, the signal converting unit 112b may generate an input signal that is determined adaptively, among the plurality of input modes described above, according to a type of an application that is active or running and/or the application's execution phase. That is, the signal converting unit 112b may operate in a specific input mode that is determined automatically according to a type of an application that is running and/or the application's execution phase. The execution unit 114 may transmit information on a type of an application that is running and/or the application's execution phase, or may transmit a mode selection signal determined based on the information on a type of an application that is running and/or the application's execution phase to the signal converting unit 112b. In the former case, an input mode in which the signal converting unit 112b operates may be determined inside the signal converting unit 112b, while in the latter case, an input mode in which the signal converting unit 112b operates may be determined in the execution unit 114 or in a higher application layer. The signal converting unit 112b may operate in an input mode according to a mode selection signal received from the execution unit 114. A specific example where an input mode of the signal converting unit 112b is adaptively determined according to a type of an application that is running and/or the application's execution phase will be described later.

In the present disclosure, methods of implementing the input processing unit 112 and the execution unit 114 on a specific operating system (OS) of the mobile terminal 100 are not specifically limited. However, the input processing unit 112 may receive fingerprint data or touch input data from the fingerprint reading unit 122, and process the received data to generate a verification result signal or a signal according to a specific input mode. Further, the execution unit 114 may control whether applications are executed based on the received verification result signal or a specific input signal, control applications to be executed according to an input signal, or control operations of an application that is running according to an input signal.

The input processing unit 112 may be configured to communicate with the fingerprint reading unit 122, which is a hardware unit, and the execution unit 114 may be configured to communicate with application layers. For example, both the input processing unit 112 and the execution unit 114 may be configured in a lower application layer. Further, both the input processing unit 112 and the execution unit 114 may be configured in an application layer, in which touch input data acquired from the fingerprint reading unit 122 is transmitted to a lower application layer without being processed, such that the data may be converted into a specific input signal appropriate for an application that is running in an application layer.

A mobile terminal, e.g., a smartphone or a smart pad, is largely composed of a hardware layer, a platform that processes and transmits signals input from the hardware layer, and an application layer including various applications that are operated based on the platform. Depending on operating systems of mobile electronic devices, the platform is divided into an Android™ platform, a Windows Mobile® platform, an iOS® platform, and the like, according to an operating system of a mobile electronic device, in which the platforms have structures slightly different from each other, but basically perform identical operations. The Android platform is comprised of a Linux® kernel layer, a library layer, and a framework layer. The Windows mobile platform is comprised of a Windows Core layer and an interface layer. Further, the iOS platform is comprised of a Core OS layer, a Core service layer, a media layer, and a Cocoa Touch layer. Each layer may be indicated as a block, and a framework layer of the Android platform, or similar layers of other platforms, may be defined as a software block.

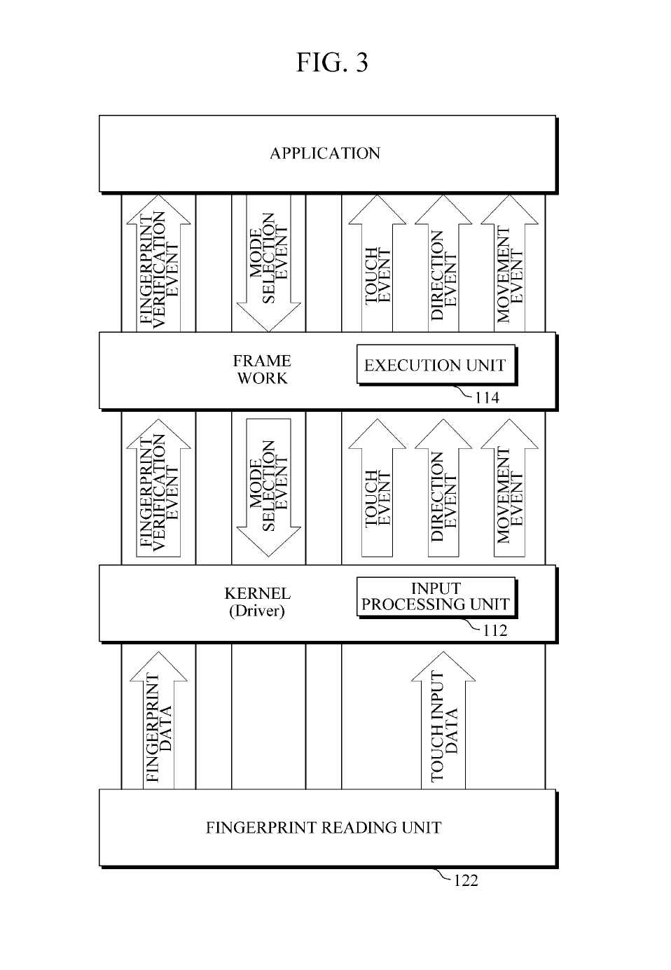

FIG. 3 is a diagram illustrating an example of the configuration of FIG. 2 embodied on the Android operating system (OS) according to exemplary embodiments. A signal (which is referred to as an event in the Android operating system) transmitted through each layer is also illustrated in FIG. 3, of which specific details will be omitted as they are identical to those described with reference to FIG. 2. Further, the example illustrated in FIG. 3 is merely illustrative, and may be modified according to examples.

Referring to FIG. 3, the input processing unit 112 and/or the fingerprint processing unit 112a may be implemented in a kernel, since the kernel layer is where fingerprint data or touch input data is received and processed in a mobile terminal with the Android OS mounted thereon. Further, the execution unit 114 may be implemented in a framework, since the framework layer is where a verification result signal or an input signal of a specific mode is received, and a specific event signal related to execution of an application is transmitted to an application layer in a mobile terminal with the Android OS mounted thereon. Further, in FIG. 3, an identical event signal (e.g., fingerprint verification event, mode selection event, touch event, direction event, movement event) is transmitted among an application, a framework, and a kernel, which is merely illustrative for convenience of description, and information included therein may vary depending on operating systems. For example, the fingerprint reading unit 122 may transmit fingerprint data and touch input data to the input processing unit 112 in a kernel (driver) layer. The input processing unit 112 may transmit a fingerprint verification event and/or at least one of a touch event, a direction event, and a movement event to the execution unit 114 in a framework layer. The execution unit 114 may transmit the fingerprint verification event and/or at least one of the touch event, the direction event, and the movement event to an application. The application may transmit a mode selection event to the execution unit 114 in the framework layer; and the execution unit 114 may transmit the mode selection event to the input processing unit 112 in the kernel (driver) layer.

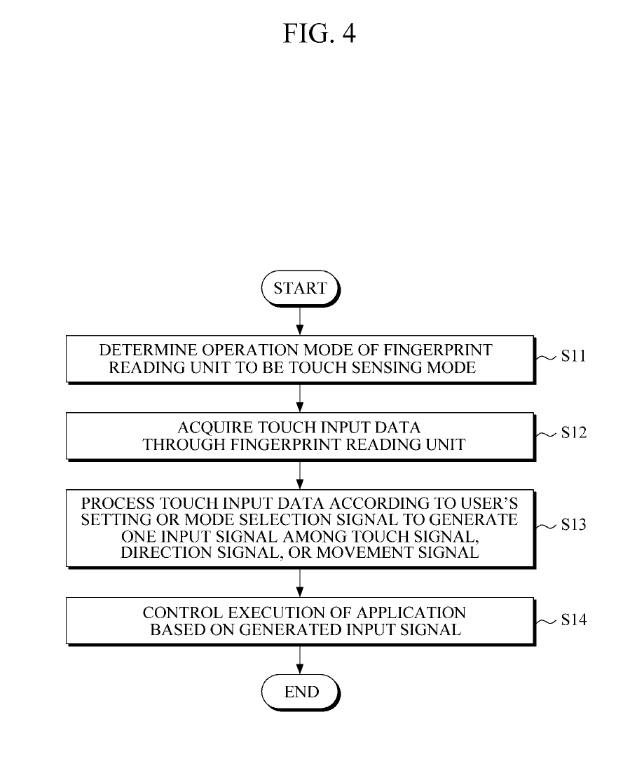

FIG. 4 is a flowchart illustrating an example of processing user input through a fingerprint reading unit of a mobile terminal according to exemplary embodiments. A user input process illustrated in FIG. 4 may be performed by the control unit 110, specifically by the input processing unit 112 and the execution unit 114 as illustrated in FIG. 1. Hereinafter, a user input process according to exemplary embodiments will be described briefly. The above description on the input processing unit 112 and the execution unit 114 may be applied to details that are not specifically described hereinafter.

An operation mode of the fingerprint reading unit 122 installed in the mobile terminal 100 is determined to be a touch sensing mode in operation S11. The operation mode of the fingerprint reading unit 122 in operation S11 may occur by executing an environment setting of the mobile terminal 100, or by executing a menu or an application related to an operation mode setting of the fingerprint reading unit 122. Operation S11 may be operated automatically according to a specific algorithm based on a type of an application that is running and/or the application's execution phase. For example, the fingerprint reading unit 122 may operate automatically in a touch sensing mode in at least the following cases: where a menu image is displayed on a screen; a specific browser is running for Internet connection; a gallery application is running; a list of a phone book, a list of multimedia content, a list of documents, or the like is displayed on a screen; a drawing application is running; a map application is running; and the like. As described above, an operation mode selector may be provided in the mobile terminal 100 to enable a user to set an operation mode of the fingerprint reading unit 122, to enable an operation mode to be adaptively selected or determined according to a type of an application that is running and/or the application's execution phase, or to enable the fingerprint reading unit 122 to operate in the set or determined operation mode.

The mobile terminal 100 acquires touch input data in operation S12 from the fingerprint reading unit 122. In the sweep-type fingerprint reading unit 122, the fingerprint reading unit 122 may sense touch input of a user that sweeps a sensing surface, and the fingerprint reading unit 122 may generate touch input data. The touch input data may be information on positions of a touching device (e.g., finger, a pen, a stylus, etc.) measured at a specific time. Further, the mobile terminal 100 may acquire a plurality of pieces of position information (touch input data) at a specific time interval in operation S12, for example, in a multitouch operation or as multiple touches within the specific time interval.

The mobile terminal 100 processes touch input data acquired in operation S12 according to a user's setting or to a mode selection signal to generate a specific input signal in operation S13. Operation S13 may be performed by the signal converting unit 112b of the mobile terminal 100. More specifically, the signal converting unit 112b of the mobile terminal 100 processes touch input data received from the fingerprint reading unit 122 to obtain displacement (ΔX/ΔY), from which any one input signal among a touch signal (including position information and/or gesture information), a direction signal, or a movement signal may be generated. As described above, an input mode, according to which the signal converting unit 112b of the input processing unit 112 generates an input signal, may be determined by a user's explicit selection, and/or may be determined adaptively according to a type of an application that is running or to the application's execution phase.

Further, the mobile terminal 100 controls execution of applications according to a generated input signal in operation S14. Operation S14 may be performed by the execution unit 114 of the mobile terminal 100. For example, if a signal generated in operation S13 is a touch signal, the execution unit 114 may move an image on a screen, turn over a page, enlarge/reduce an image displayed on a display, or the like, according to the touch signal in an application that is running. Further, if a signal generated in S13 is a direction signal, the execution unit 114 may change highlighted or pre-selected items among a plurality of items displayed on a display according to a direction indicated by the direction signal. Further, if a signal generated in S13 is a movement signal, the execution unit 114 may move a position of a mouse pointer according to a movement signal, or may move a background image (e.g., a map) in an opposite direction of the movement signal or enable a drawing application to be executed in the background image.

Hereinafter, examples of executing applications by processing touch input through a fingerprint reading unit installed in a mobile terminal according to exemplary embodiments will be described in detail. The following examples are merely illustrative to explain controlling applications by processing a user's touch input (e.g., touch input data) from a fingerprint reading unit of a mobile terminal using an input signal optimized for application execution phases. Accordingly, the scope of the present disclosure is not limited thereto.

FIGS. 5A and 5B are images displayed in an executing gallery application, in which FIG. 5A is an example of an initial image of a running image viewer application displayed on a screen, and FIG. 5B is an image displayed when the image selected in the initial image of FIG. 5A is clicked.

Referring to FIG. 5A, once a gallery application is initially executed, or a gallery application is executed (e.g., by clicking or pressing enter) by selecting a specific folder in the initial execution image, images stored in the folder and/or in a sub folder are displayed in a list and/or in an array on a display. In the execution phase of FIG. 5A, it is appropriate that a user's touch input through a fingerprint reading unit is considered to be a request for changing the highlighted or pre-selected items to be displayed on a display, e.g., a request for changing a sub folder or image. Accordingly, a mobile terminal may process a user's touch input through a fingerprint reading unit, e.g., touch input data, to generate a direction signal, and may control execution of the application based on the generated direction signal. That is, in the image of FIG. 5A, the fingerprint reading unit 122 (see FIG. 2) may operate in a touch sensing mode, and the signal converting unit 112b (see FIG. 2) of a mobile terminal may operate in a direction mode. Further, highlighted items may be changed according to a generated direction signal, as indicated by an arrow shown in FIG. 5A. Further, once an execution input is received as indicated in a black box in FIG. 5A, it is considered to be a request for execution of a highlighted item, and a selected image may be enlarged to be displayed on a display. Methods for implementing execution input are not specifically limited, and a side button, a dome key, or a dome key installed at the bottom of or adjacent to a fingerprint reading unit or a long touch, several touches, or a multitouch of the fingerprint reading unit 122 may be used.

Referring to FIG. 5B, once a highlighted image is selected in the image of FIG. 5A, and the execution input is received, the selected image is displayed on a whole display screen. In the execution phase of FIG. 5B, \ a user's touch input through a fingerprint reading unit may be considered to be a request for moving (indicated by a unidirectional arrow in FIG. 5B) or reducing/enlarging (indicated by a bidirectional arrow in FIG. 5B) images displayed on a display. Accordingly, a mobile terminal may generate a touch signal by processing a user's touch input through a fingerprint reading unit, e.g., touch input data, and may control execution of an application based on the generated touch signal. That is, in the image of FIG. 5B, the fingerprint reading unit 122 (see FIG. 2) may operate in a touch sensing mode, and the signal converting unit 112b (see FIG. 2) of a mobile terminal may operate in a touch mode.

FIGS. 6A and 6B are diagrams illustrating an image of connection to a website, for example, www.Yahoo.com, that may be a mobile Internet portal site, through an Internet browser, in which FIG. 6A is an initial image of connection to the site, and FIG. 6B is an image displayed when a news item selected in the image of FIG. 6A.

Upon connecting to a specific Internet site, a web page configured by a provider of the Internet service is generally displayed on a display. When connecting to an Internet portal site, lists of various menus and news are displayed on a display in a specific format. In the execution phase of FIG. 6A, a user's touch input through a fingerprint reading unit may be considered to be a request for changing highlighted or pre-selected items to be displayed on a display, e.g., a request for changing a sub folder or image. Accordingly, a mobile terminal may process a user's touch input through a fingerprint reading unit, e.g., touch input data, to generate a direction signal, and may control execution of an application based on the generated direction signal. That is, in the image of FIG. 6A, the fingerprint reading unit 122 (see FIG. 2) may operate in a touch sensing mode, and the signal converting unit 112b (see FIG. 2) of a mobile terminal may operate in a direction mode. Further, in this case, highlighted items may be changed according to a generated direction signal, as indicated by an arrow shown in FIG. 6A. Further, in FIG. 6A, following input of a downward direction signal, when a highlighted item is changed from a content category (“News”) to a first news item (“War vote . . . ”), and an execution input is received as indicated in a black box in FIG. 6A, it is considered to be a request for execution of the highlighted item, such that a selected news item (see FIG. 6B) may be displayed on a display. As described above, there are no specific limits to the method for implementing execution input. For example, a different category (e.g., “Sports”) may be selected according to a similar operation in a different direction.

Referring to FIG. 6B, once a first news item (“War vote . . . ”) is clicked, a web page of the clicked news is displayed on a whole display screen. According to a user's setting for a web page size and/or a display, the whole or a part of a web page may be displayed on a screen. In the execution phase of FIG. 6B, a user's touch input through a fingerprint reading unit may be considered to be a request for moving by scrolling (indicated by a bidirectional arrow in FIG. 6B), or for reducing/enlarging (indicated by a unidirectional arrow in FIG. 6B) a web page displayed on a display. Accordingly, a mobile terminal generates a touch signal by processing a user's touch input through a fingerprint reading unit, e.g., touch input data, and controls execution of an application based on the generated touch signal. That is, in the image of FIG. 6B, the fingerprint reading unit 122 (see FIG. 2) operates in a touch sensing mode, and the signal converting unit 112b (see FIG. 6B) of a mobile terminal operates in a touch mode.

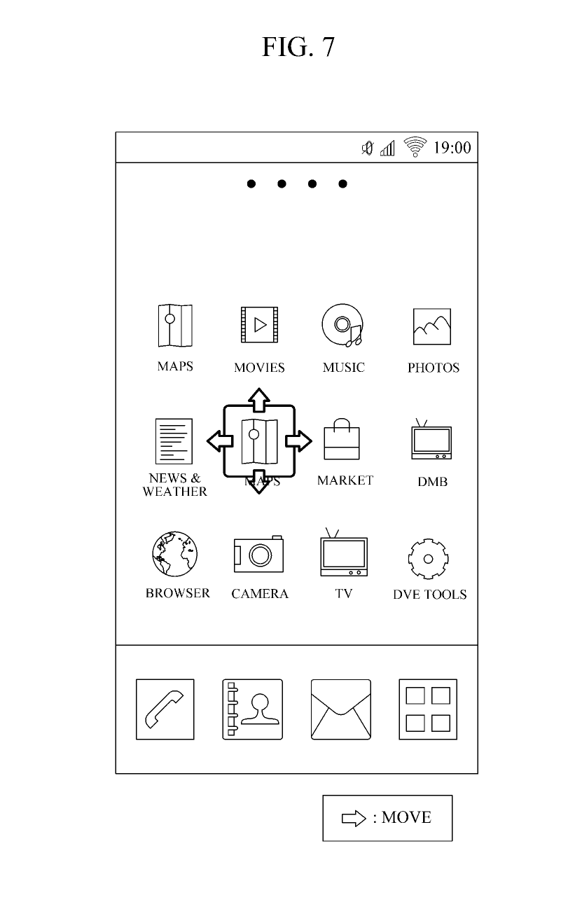

FIG. 7 is a diagram illustrating an example of a menu image of a mobile terminal with the Android OS mounted thereon according to exemplary embodiments. Referring to FIG. 7, icons of applications installed in a mobile terminal are displayed in an array in a menu image. In the execution phase of the application as shown in FIG. 7, a user's touch input through a fingerprint reading unit may be considered to be a request for changing a highlighted icon to be displayed on a display, or a request for executing an application indicated by the highlighted icon. Accordingly, a mobile terminal generates a direction signal to move the selection of the icon by processing a user's touch input through a fingerprint reading unit, e.g., touch input data, and controls execution of an application or selected icon based on the generated direction signal. That is, in the image of FIG. 7, the fingerprint reading unit 122 (see FIG. 2) operates in a touch sensing mode, and the signal converting unit 112b (see FIG. 2) operates in a direction mode.

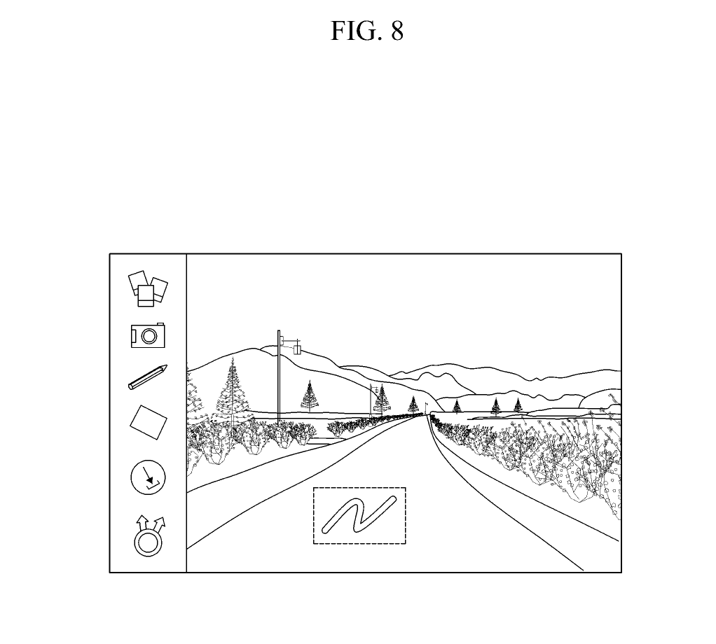

FIG. 8 is a diagram illustrating an example of an image displayed when executing a drawing application in a mobile terminal with the Android OS mounted thereon according to exemplary embodiments. FIG. 8 illustrates an image of a certain figure (inside the dotted line box) drawn on a road with a landscape image in background. For the operation of drawing such figure image as illustrated in FIG. 8, a user's touch input may be considered to be points to draw a line in a background image. For example, a consecutive touch input may indicate a trajectory of points to be included in the drawn line. Accordingly, a mobile terminal may generate a movement signal by processing a user's touch input through a fingerprint reading unit, e.g., touch input data, and may control execution of an application based on the generated movement signal. That is, in the image of FIG. 8, the fingerprint reading unit 122 (see FIG. 2) may operate in a touch sensing mode, and the signal converting unit 112b (see FIG. 2) may operate in a movement mode.

As described above, by using a fingerprint reading unit mounted on a terminal, user verification may be performed, and input signals of various modes suitable for the types or phases of running applications may be generated, thereby controlling execution of applications. Accordingly, users may have new user experiences through the fingerprint reader, and may use applications more easily and conveniently.

The methods and/or operations described above may be recorded, stored, or fixed in one or more computer-readable storage media that include program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network, and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A terminal comprising:
a fingerprint reader to acquire fingerprint data or to acquire touch input data according to a mode of the fingerprint reader;
an input processor comprising a signal converter to convert the touch input data received from the fingerprint reader into an input signal according to a mode of the signal converter, the mode of the signal converter being determined according to an application or a user input; and
an execution controller to control the application according to the input signal received from the signal converter.

2. The terminal of claim 1, wherein the mode of the signal converter is determined according to an execution phase of the application.

3. The terminal of claim 1, wherein the input processor further comprises a fingerprint processor to perform user verification on fingerprint data received from the fingerprint reader.

4. The terminal of claim 3, wherein the execution controller controls an application according to a verification result signal received from the fingerprint processor, the verification result signal indicating a result of the user verification.

5. The terminal of claim 1, wherein the mode of the fingerprint reader is determined according to an application or an execution phase of the application.

6. The terminal of claim 5, wherein the mode of the fingerprint reader is determined between a fingerprint recognition mode and a touch sensing mode.

7. The terminal of claim 1, wherein the execution controller transmits a mode selection signal to the signal converter, the mode selection signal being based on the application or an execution phase of the application and indicating the mode of the signal converter.

8. The terminal of claim 1, wherein the execution controller transmits information indicating the application or an execution phase of the application to the signal converter, and the signal converter determines the mode of the signal converter.

9. The terminal of claim 1, wherein the mode of the signal converter is determined between a touch input mode, a direction input mode, a movement input mode,
wherein, in the touch input mode, the signal converter generates a touch signal from the touch input data,
wherein, in the direction input mode, the signal converter generates a direction signal from the touch input data, and
wherein, in the movement input mode, the signal converter generates a movement signal form the touch input data.

10. A method of controlling an application of a terminal, the method comprising:
determining a mode of a fingerprint reader from among a fingerprint recognition mode and a touch sensing mode;
acquiring touch input data through the fingerprint reader if the mode of the fingerprint reader is determined as the touch sensing mode;
generating an input signal from the touch input data according to an application or a user input; and
controlling the application according to the input signal.

11. The method of claim 10, wherein the input signal is generated from the touch input data according to an execution phase of the application.

12. The method of claim 10, wherein the input signal is generated as a touch signal, a direction signal, or a movement signal.

13. The method of claim 12, wherein the touch signal comprises at least one of gesture information and coordinate information.

14. The method of claim 12, wherein the direction signal comprises information of touch input movement direction.

15. The method of claim 12, wherein the movement signal comprises information of difference of positions of an indicator.

16. The method of claim 10, further comprising:
acquiring fingerprint data through the fingerprint reader if the mode of the fingerprint reader is determined as the fingerprint recognition mode.

17. The method of claim 10, further comprising:
determining a mode of a signal converter according to the application or the execution phase of the application,
wherein the signal converter generates the input signal from the touch data.

18. The method of claim 10, wherein the mode of the fingerprint reader is determined according to the application or an execution phase of the application.
